(19) United States
(12) Patent Application Publication
(10) Pub. No.: US 2004/0178125 A1
(43) Pub. Date: Sep. 16, 2004

(54) Method of removing aromatic halide compound contamination from oil

(76) Inventors: Katsuhiko Nakajoh, Yokohama-shi (JP); Takehiko Muramatsu, Yokohama-shi (JP); Masao Kon, Yokohama-shi (JP); Hiroaki Kinoshita, Chigasaki-shi (JP); Tomohiro Todoroki, Chigasaki-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/746,158

(22) Filed: Dec. 23, 2003

(30) Foreign Application Priority Data
Dec. 27, 2002 (JP) P2002-381980

(51) Int. Cl. C10G 21/12; B01D 3/02; B01D 11/00

(52) U.S. Cl. 208/262.1; 208/262.5; 196/106; 196/14.52

(57) ABSTRACT

In a method of removing an aromatic halide from oil containing the aromatic halide, the aromatic halide compound being extracted from the oil containing the aromatic halide compound safely and highly efficiently, by extraction using an extracting solvent containing 1,3-dialkyl-2-imidazolidinone which is sulfur free and has extremely high extraction separation ability, or by using an extraction solvent containing an aqueous solution of 1,3-dialkyl-2-imidazolidinone. A system of removing aromatic halide compound from oil containing the aromatic halide compound includes a first supply source of a first extracting solvent containing 1,3-dialkyl-2-imidazolidinone; a second supply source of the oil containing the aromatic halide compound; and a first extractor which extracts the aromatic halide compound from the oil containing the aromatic halide compound supplied from the second supply source, by the first extracting-solvent supplied from the first supply source.

### CROSS REFERENCE TO RELATED APPLICATION

This application is based upon and claims the benefit of priority from prior Japanese Patent Application No. 2002-381980, filed on Dec. 27, 2002; the entire contents of which are incorporated herein by reference.

### BACKGROUND OF THE INVENTION

1. Field of the Invention

The present invention relates to a method of selectively removing an aromatic halide compound from oil such as tar, mineral oil, and the like, wherein the aromatic halide compound has contaminated the oil.

2. Description of the Related Art

A method to process insulation oil by combustion at a high temperature and a method to process PCB by a chemical reaction with alkaline chemicals have been widely used as methods of rendering a harmful aromatic halide compound harmless, wherein the harmful aromatic halide compound is one such as PCB (polychlorinated biphenyl) and the like, which is slightly contained in an oil such as insulation oil.

However, the whole oil is an object to be processed, while an amount of PCB to be processed is minute. Therefore, the methods require processing of a large amount of oil. A large scale of processing equipment is required and a burden of energy cost accompanied by the process is far from negligible. Furthermore, recycling of the oil processed together with PCB by the conventional methods is not easy, and incurs waste from the viewpoint of effective utilization of resources.

On the other hand, multi distillation corresponding to a high boiling point and a high melting point such as atmospheric distillation, vacuum distillation, azeotropic distillation. and the like, a distillation method combined with liquid-liquid extraction, and liquid-liquid extraction have been known as methods to concentrate and remove an aromatic halide compound from oil.

However, the conventional distillation and removing methods have been mainly used as no more than pretreatment for componential analysis in processing a liquid, and no embodiments of a means to concentrate and remove only the harmful aromatic halide compound from a large amount of oil have been known.

In case of processing a harmful aromatic halide compound slightly contained in oil, to concentrate or remove only the harmful aromatic halide compound in advance could result in drastically reduced energy costs and equipment costs incurred by a decomposing process, since the amount to be processed by the decomposing process could be drastically reduced.

However, a method to remove an aromatic halide compound from oil by employing the conventional distillation method has problems such as requiring accurate and complicated processes, the pyrolysis of an object to be processed by heat during distillation, a reaction such as polymerization and the like, a large amount of energy consumption, a large amount of distillation apparatus, and the like.

Furthermore, in a method of removing an aromatic halide compound from oil by employing the conventional extraction method, DMSO (dimethylsulfoxide), sulfolane, and the like are typically used as extracting solvent. However, since these extracting solvents contain sulfur(S), it is necessary to remove the aromatic halide compound from the extracting solvents completely as pretreatment before performing pyrolysis of the extracted aromatic halide compound. Incomplete removal of the aromatic halide compound from the extracting solvents could result in the generation of a toxic gas containing an S element such as sulfur dioxide and the like, catalyst poisoning, and apparatus corrosion. DMSO (dimethylsulfoxide) and sulfolane have a solidifying point in the vicinity of room temperature (DMSO: s.p.=18.54° C., sulfolane: s.p.=28.54° C.), therefore, there is concern that some trouble regarding apparatus may be caused if these extracting solvents are used in the vicinity of room temperature. Accordingly, these extracting solvents are lacking in ease of handling.

On the other hand, conventional extracting solvents other than DMSO do not have satisfactory extraction ability.

Therefore, methods of removing the aromatic halide compound, such as a method removing and concentrating the aromatic halide compound from oil more efficiently and more safely, a method having good compatibility towards the conventional process to render objects harmless, and furthermore a method to enable recycling of oil, are desired in view of the conventional problems described above.

### SUMMARY OF THE INVENTION

An object of the present invention is to provide a method of removing and concentrating an aromatic halide compound from oil more efficiently and more safely.

A method of removing aromatic halide compound from oil according to a first aspect of this invention, includes extracting the aromatic halide compound from oil containing the aromatic halide compound by using a first extracting solvent containing 1,3-dialkyl-2-imidazolidinone.

A system of removing aromatic halide compound from oil containing the aromatic halide compound according to a second aspect of this invention, includes a first supply source of an extracting solvent containing 1,3-dialkyl-2-imidazolidinone; a second supply source of oil containing the aromatic halide compound; and an extractor which extracts the aromatic halide compound from the oil containing the aromatic halide compound supplied from the second supply source, by the extracting solvent supplied from the first supply source.

According to the method and the system of removing the aromatic halide compound of the present invention, the extracting solvent containing 1,3-dialkyl-2-imidazolidinone does not contain a sulfur component, and furthermore, has very high extraction ability as compared with widely conventional extracting solvents used Furthermore, since a solidifying point of 1,3-dialkyl-2-imidazolidinone is 8.2° C., being less than the solidifying point of 10-20° C. of the conventional extracting solvents, there is no trouble caused by solidifying solvent with regard to apparatuses. Therefore, if is possible to remove the aromatic halide compound harmlessly and with high efficiency. Also, after processing the extraction the oil can be recycled.

Note that in the present invention, generally oil refers to as an oily substance in liquid form at ambient temperatures or by heat Furthermore, an aromatic halide compound refers to as a compound containing aromatic rings and halogens.

### BRIEF DESCRIPTION OF THE DRAWINGS

FIG. 1 is a schematic block diagram of a first embodiment according to the present invention showing a configuration of a system which removes an aromatic halide compound from contaminated oil.

FIG. 2 is a schematic block diagram of a third embodiment according to the present invention showing a configuration of a system which removes an aromatic halide compound from contaminated oil.

FIG. 3 is a schematic block diagram of a fourth embodiment according to the present invention showing a configuration of a system to remove an aromatic halide compound from contaminated oil.

FIG. 4 is a graph showing the PCB distribution coefficient of various extracting solvents in Example 1 and Comparative Examples 1 to 4.

FIG. 5 is a graph showing the mutual solubility of various extracting solvents with insulation oil in Example 1 and Comparative examples 1 to 4.

FIG. 6 is a graph, with regard to an extracting solvent consisting of DMI or the aqueous solution thereof, showing the relationship between the water concentration in the extracting solvent and the mutual solubility with insulation oil in Examples 1 to 4.

FIG. 7 is a graph, with regard to an extracting solvent consisting of DMI or the aqueous solution thereof, showing the relationship between the water concentration in the extracting solvent and the PCB distribution coefficient in Examples 1-4.

FIG. 8 is a graph showing the relationship between the water concentration in DMI or the aqueous solution thereof and the PCB recovery rate at the second extraction process in Examples 6 to 9.

FIG. 9 is a graph showing the relationship between the volume ratio (hexane/DMI) and the PCB recovery rate at the second extraction process in Example 7 and Examples 10 to 12.

### DETAILED DESCRIPTION OF THE EMBODIMENTS

### First Embodiment

A first embodiment according to the present invention is a method of removing an aromatic halide compound from oil contaminated with aromatic halide compound, and includes 1) an extraction process, in which the aromatic halide is extracted into an extracting solvent from the oil contaminated with the aromatic halide to separate the aromatic halide compound from the contaminated oil, and 2) a distillation process, in which the aromatic halide is separated from the extracting solvent and recovered by distilling the extracting solvent containing the dissolved aromatic halide.

The main feature of the method in the first embodiment is to remove aromatic halide compound highly efficiently and safely by using a solvent containing 1,3-dialkyl-2-imidazolidinone as an extracting solvent. The extracting solvent is an aprotic polar solvent, which does not contain a sulfur component and is relatively harmless.

Note that in the first embodiment, examples of the oil to be processed include mineral oil such as petroleum, light oil, heavy oil, and the like, vegetable oil such as olive oil, palm oil, and the like, tar such as coal liquid, coal tar, and the like, petroleum reformed oil, animal oil, resin oil, and the like, and in addition, wax or shortening which goes into a liquid form at about 100° C. and the like.

Furthermore, in the first embodiment, examples of the aromatic halide compound suitable for a separation process include a type of PCB (polychlorinated biphenyl), a type of dioxin, a type of furan, DDT, CNP (pentachlorophenol), polybromidebiphenyl and the like.

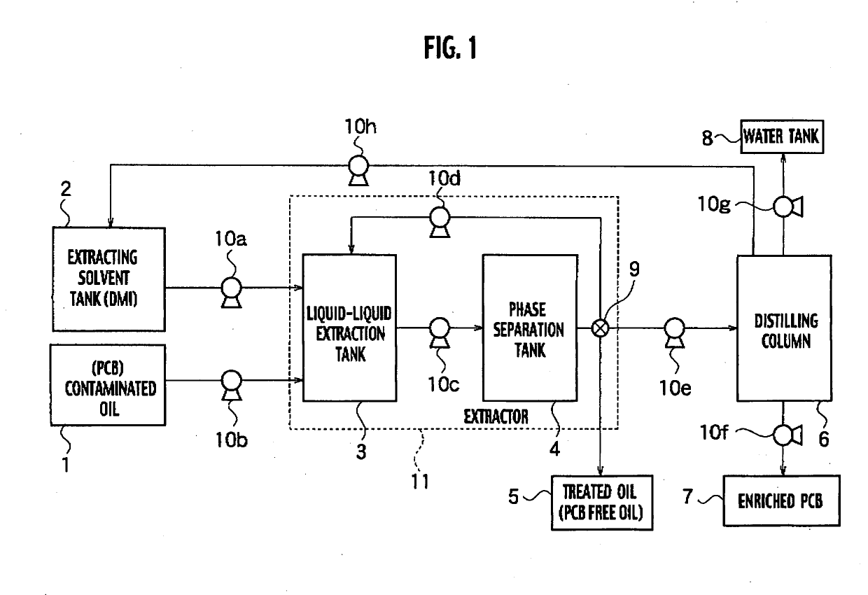

FIG. 1 is a schematic block diagram of a separation process system used for a method of removing an aromatic halide compound of the first embodiment. Hereinafter, a method of removing the aromatic halide compound according to the first embodiment will be described concretely with reference to the block schematic diagram.

Firstly, oil contaminated with the aromatic halide compound to be processed and an extracting solvent containing 1,3-dialkyl-2-imidazolidinone used as an extracting solvent are prepared in an oil tank 1 as a supply source and an extracting solvent tank 2 as a supply source, respectively. Note that in the first embodiment, 1,3-dialkyl-2-imidazolidinone itself is used as the extracting solvent.

The oil in the oil tank 1 and 1,3-dialkyl-2-imidazolidinone in the extracting solvent tank 2 are transferred to a liquid-liquid extraction tank 3 in an extractor 11 by a transfer pump 10a and 10b. Then, both sides contact, the aromatic halide compound contained in the oil is extracted into the 1,3-dialkyl-2-imidazolidinone extracting solvent. Furthermore, the oil and the 1,3-dialkyl-2-imidazolidinone are transferred to a phase separation tank 4 by a transfer pump 10c, and are phase-separated into an extract of 1,3-dialkyl-2-imidazolidinone in which aromatic halide compound is dissolved and a raffinate consisting mainly of the oil. As to the raffinate after the phase separation, concentration of the aromatic halide compound in the raffinate is measured by a concentration monitor 9. If the concentration has not reached a prescribed objective concentration, the raffinate is returned to the liquid-liquid extraction tank 3 by a circulating pump 10d, then th extraction of the aromatic halide compound remaining in the raffinate is made again. Thus, the extraction and the separation, that is, the extraction process is repeated until the concentration of the aromatic halide compound in the raffinate reaches the prescribed concentration. Note that the extractor 11 may be a batch extractor which has the liquid-liquid extraction tank 3 and the phase separation tank 4 as independent tanks, and a continuous extractor in which liquid-liquid extraction and phase separation can be continuously repeated. In this case, the concentration monitor 9, and various pumps 10c and 10d are not necessarily required.

The raffinate, in which concentration of the aromatic halide compound is reduced to a prescribed objective concentration or below, is removed from the phase separation tank 4 and is stored in a treated oil tank 5. Since the aromatic halide compound has been removed from the oil stored in the treated oil tank 5, the treated oil can be recycled. Note that when the insulation oil itself contain impurities other than the aromatic halide compound, further refining means may be added between the phase separation tank 4 and the treated oil tank 5, if necessary.

On the other hand, 1,3-dialkyl-2-imidazolidinone of the extracting solvent in which the aromatic halide compound is dissolved is transferred to a distilling column 6 by a transfer pump 10e, where a separating operation by distillation is carried out. By the operation, 1,3-dialkyl-2-imidazolidinone used as the extracting solvent is separated and recovered. The separated 1,3-dialkyl-2-imidazolidinone is transferred to the extracting solvent tank 2 by a transfer pump 10h, and can be recycled to be used as an extracting solvent again. The enriched aromatic halide compound remaining after distillation is transferred to an aromatic halide compound enrichment tank 7 by a transfer pump 10f.

When the enriched aromatic halide compound is a harmful substance, for example, PCB and the like, a decomposing processing technique such as a conventional high temperature heat treatment, alkaline reaction processing, and the like, is employed for decomposing it and rendering it harmless.

Note that while 1,3-dialkyl-2-imidazolidinone is used as the extracting solvent in the first embodiment, any other solvents or dispersant agents containing various liquids or solids (for example, activated carbon or fine metal particles) which contain 1,3-dialkyl-2-imidazolidinone may also be used. The same applies to other embodiments.

Hereinafter, further details of the extraction process and the separation process by distillation will be described.

<Extraction Process>

The extraction process is a process to extract an aromatic halide compound from contaminated oil into 1,3-dialkyl-2-imidazolidinone by bringing the oil contaminated with the aromatic halide compound into contact with an 1,3-dialkyl-2-imidazolidinone extracting solvent. During the extraction, a liquid temperature of 1,3-dialkyl-2-imidazolidinone of the extracting solvent is preferably regulated in a range of 10° C. to 80° C.

Furthermore, the mass ratio (S/F) of the mass of the oil (S) containing the aromatic halide compound corresponding to a feed in the extraction operation to the mass of 1,3-dialkyl-2-imidazolidinone of the extracting solvent (extractant) is not particularly limited, however, the S/F is preferably in a range of 0.1 to 5 to process the extraction.

The extraction operation method is not particularly limited, however a batch extraction method, a multiple extraction method, a continuous differential extraction method, a countercurrent multistage extraction method, a reflux extraction method, a fractional extraction method, a centrifugal extraction method utilizing centrifugal force and the like may be employed. When a stage number and an amount of an extracting solvent are the same, the countercurrent multistage extraction method is preferable compared with the multiple extraction method which repeats a batch extraction operation more than once, from the view point of high extraction rate and wide array of industrial utilization.

<Separation Process by Distillation;>

The separation process by distillation is a process to separate into 1,3-dialkyl-2-imidazolidinone and a concentrate of the aromatic halide compound by distilling 1,3-dialkyl-2-imidazolidinone containing an aromatic halide compound.

The distillation conditions preferably include having a distillation pressure in a range of 4 to 470 mmHg and a distillation temperature of 70 to 180° C. Note that the distillation pressure condition correlates with the temperature condition. When the distillation pressure is set low, the distillation temperature is preferably relatively lowered.

By setting the above mentioned condition, it is possible to distill 1,3-dialkyl-2-imidazolidinone. The distillation method is not particularly limited, however a stage distilling column is preferably used.

Note that it is possible to adjust the enrichment ratio of the aromatic halide compound according to a later decomposing process technique for detoxification. When 1,3-dialkyl-2-imidazolidinone does not influence decomposition, the complete removal of the aromatic halide compound and 1,3-dialkyl-2-imidazolidinone is not necessarily required.

By the method of removing the aromatic halide compound according to the first embodiment described above, 1,3-dialkyl-2-imidazolidinone used as the extracting solvent does not contain a sulfur component and is relatively harmless, enabling a safe separation process. Furthermore, the solvent has high extraction separation ability to the aromatic halide compound compared with the ability of the conventional extracting solvent, resulting in carrying out an efficient separation process. As a result, it is possible that the extraction rate of the aromatic halide compound from the oil is in the range of 99.99% or more, and the recovery rate of the aromatic halide compound is in the range of 98.6% or more.

Therefore, the recycling of the oil is possible by the removing method described above, and is an effective removing method from the viewpoint of resource utilization. For example, by using the above mentioned removing method according to the first embodiment, it is possible for transformers and the like to be operated in a practical matter and at the same time for insulation oil in the operating transformers to be controlled to flow into the liquid-liquid extraction tank 3 at slow speed, and for PCB to be removed from the insulation oil as well as any PCB contaminated components (insulator paper, coil, wood, and the like) while the regenerated insulation oil after the separation can be returned to the transformer and recycled. Accordingly, without talking a machine apart, it is possible to remove PCB contamination in the transfer. Also, treated insulation oil can be recycled as oil for a transfer. That is, in this case, a piping system to connect the transformers directly is prepared as a supply source, instead of the treated oil tank 2, and the insulation oil is removed from the transformers and the regenerated insulation oil is returned directly to the transformers. Therefore, the insulation oil can be circulated. Furthermore, it is possible to recover and recycle 1,3-dialkyl-2-imidazolidinone used as the extracting solvent as well.

In addition, 1,3-dialkyl-2-imidazolidinone used as the extracting solvent does not contain a sulfur component Therefore, when a combustion method is used to render the removed and recovered aromatic halide compound harmless, toxic gas originated from the sulfur component is not generated. And when a catalyst method is used to render the aromatic halide compound harmless, a catalyst poisoning originated from the sulfur component is prevented. Thus, when the process to render an object harmless is carried out, processes are not particularly limited and various types of the conventional methods can be employed.

### Second Embodiment

A second embodiment according to the present invention is a method of removing an aromatic halide compound from oil contaminated with the aromatic halide compound, and in the same manner as in the first embodiment, includes 1) an extraction process, in which the aromatic halide is extracted into an extracting solvent from the oil contaminated with the aromatic halide to separate the aromatic halide compound from the contaminated oil by dissolving it in the extracting solvent, and 2) a distillation process, in which the aromatic halide is separated from the extracting solvent and recovered by distilling the extracting solvent containing the dissolved aromatic halide. The feature of the method according to the second embodiment that 1,3-dialkyl-2-imidazolidinone aqueous solution, prepared by dissolution of 1,3-dialkyl-2-imidazolidinone used in the first embodiment in water, is used as an extracting solvent. It is possible to achieve higher extraction separation rate and to remove the aromatic halide compound safely and highly efficiently.

The same oil and the same aromatic halide compound as the ones used in the first embodiment can be used.

Furthermore, in the same manner as in the first embodiment, the separation process system illustrated in FIG. 1 can be employed, and the same conditions for a basic extraction process and basic separation process by distillation can be employed.

Note that the aqueous solution is used as the extracting solvent, and therefore the oil, 1,3-dialkyl-2-imidazolidinone and water are subjected to the separation process by distillation by using the distilling column 6, as illustrated in FIG. 1. A boiling point is higher in order of water, then 1,3-dialkyl-2-imidazolidinone, and then the oil. Therefore, water is distilled first, then 1,3-dialkyl-2-imidazolidinone is distilled, and the enriched aromatic halide compound in the oil remains. After the distillation, water and 1,3-dialkyl-2-imidazolidinone, not containing the aromatic halide compound, may be returned to the extracting solvent tank 2 by using the transfer pump 10h, and they may be recycled. Furthermore, from 1,3-dialkyl-2-imidazolidinone aqueous solution after the distillation, water may be distilled and removed by using another distilling column, then the removed water may be impounded in the water tank 8 by using the transfer pump 10g.

Furthermore, in the second embodiment the 1,3-dialkyl-2-imidazolidinone aqueous solution is used as the extracting solvent. Therefore, the dissolubility to oils is more prominent by action of a higher polar aqueous solution, and the elution of the oil to the extracting solvent is prevented. Therefore, the efficiency of the removal of the aromatic halide compound from the oil is enhanced. By adding water, it is possible to reduce solidifying point of the extracting solvent to under 8° C. Therefore, when the extracting solvent is used in the vicinity of normal temperature, it is not necessary to be anxious about solidifying the extracting solvent

Note that when water concentration in an aqueous solution of 1,3-dialkyl-2-imidazolidinone used as an extracting solvent is in a range of 10% by weight or more, solubility of PCB to the extraction solvent reduces as water concentration increases, and a distribution coefficient showing an extraction ability to the aromatic halide compound at an extraction process decreases. Furthermore, when the water concentration is in a range of 30% by weight or more, an advantage over the conventional extracting solvent is lost. Furthermore, when the water concentration is in a range of 5% by weight or less, an inhibition effect on mutual solubility to oil based on the addition of water, is reduced. Therefore, the water concentration in the aqueous solution of 1,3-dialkyl-2-imidazolidinone is preferably in the range of 30% by weight or less, more preferably in the range of 5% by weight or more, but most preferably in the range 10% by weight or less.

According to the method of the removing an aromatic halide compound in the second embodiment, in a similar fashion to the first embodiment, since the aqueous solution of 1,3-dialkyl-2-imidazolidinone used as the extracting solvent does not contain a sulfur component and is relatively harmless, the separation process can be carried out safely. Furthermore, the method has higher extracting separation ability than the method using 1,3-dialkyl-2-imidazolidinone.

In addition, the recycling of oil is possible, and by employing the method of the removing in the second embodiment, it is possible that transformers are operated as a practical matter and at the same time insulation oil in the operating transformer is continuously recycled. Both 1,3-dialkyl-2-imidazolidinone and water can be recovered and recycled.

### Third Embodiment

A third embodiment in the present invention is a method and a system to remove an aromatic halide compound from oil contaminated with the aromatic halide compound. The feature in the third embodiment is to further add a reversed extraction process between the extraction process and the distillation process carried out in the first embodiment (hereinafter the initial extraction process is referred to as a “first extraction process”, and the reversed extraction process is referred to as a “second extraction process”). In the second extraction process, the solvent having a boiling point lower than the boiling point of the extracting solvent containing 1,3-dialkyl-2-imidazolidinone used in the first extracting process is used as the extracting solvent (reversed extracting solvent: Stripping solution), and the aromatic halide compound is extracted. By adding the second extraction process, the aromatic halide compound is separated more easily at the subsequent distillation process.

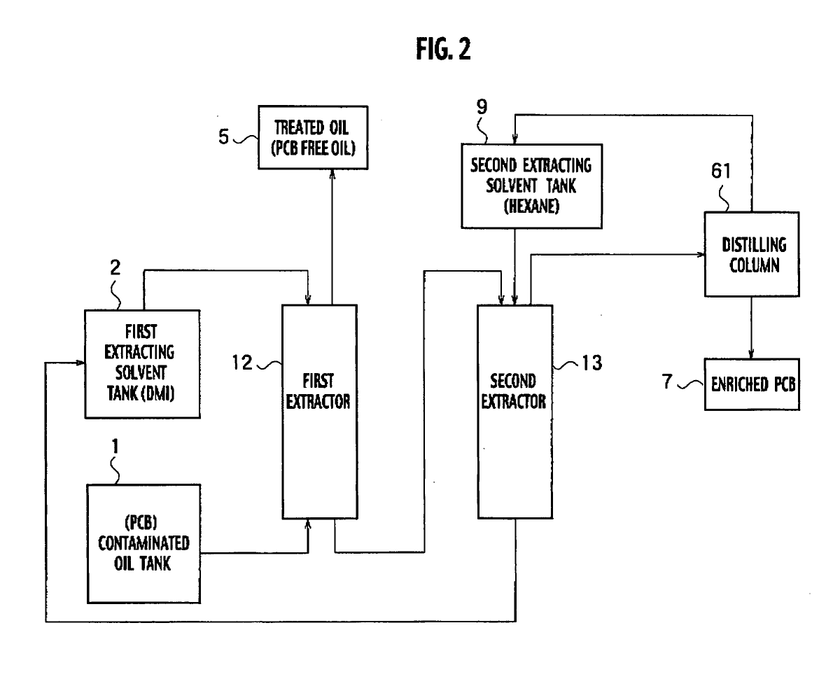

Hereinafter, a method and a system of removing the aromatic halide compound according to the third embodiment will be concretely described with reference to FIG. 2. Note that although pumps in each pipe arrangement are not given a graphic representation in the system shown in FIG. 2, pumps may be accordingly arranged in places where needed similarly to the system shown in FIG. 1. Furthermore, a continuous extracting apparatus, wherein an extraction process and a separation process are repeatedly carried out as the first and the second extractor, is illustrated by an example, and also a batch type extractor, which independently has an extraction tank and a phase separation tank as described in the first embodiment, may be employed. Note that two extractors are used in the system. Therefore, one is referred to as the first extractor, the other is referred to as the second extractor, and an extracting solvent used in each extractor is referred to as the first extracting solvent and the second extracting solvent, for convenience.

Firstly, the oil containing the aromatic halide compound to be an object processing is arranged in the oil tank 1, and 1,3-dialkyl-2-imidazolidinone used as the first extracting solvent is arranged in the extracting solvent tank 2.

The oil in the oil tank 1 and 1,3-dialkyl-2-imidazolidinone in the extracting solvent tank 2 are transferred to the continuous first extractor 12, they contact with each other, and the aromatic halide compound contaminated in the oil is extracted into 1,3-dialkyl-2-imidazolidinone of the extracting solvent.

Thus, the extract containing 1,3-dialkyl-2-imidazolidinone, in which the aromatic halide compound is dissolved, and raffinate mainly containing the oil are removed, and the raffinate is stored in the treated oil tank 5. The raffinate can be recycled as oil.

On the other hand, the 1,3-dialkyl-2-imidazolidinone, in which the aromatic halide compound is dissolved, is further transferred to the continuous second extractor 13, and the extraction operation is repeated again. In the second extraction process, a second extracting solvent is employed. The second extracting solvent preferably has a solubility of the aromatic halide compound higher than the solubility of 1,3-dialkyl-2-imidazolidinone as the first extracting solvent, has low solubility to 1,3-dialkyl-2-imidazolidinone, and has a boiling point equal to or less than 200° C. For example, versatile solvents such as hexane and the like are preferably used as the second extracting solvent. Non-polarity paraffin type hydrocarbon including n-octane, n-nonane, n-decane, and the like other than hexane may be used as well.

The second extracting solvent is stored in the second extracting solvent tank 9 as a supply source, and is supplied to the second extractor 13 as the need arises. At the second extractor 13, the extract containing the aromatic halide compound and the second extracting solvent, and raffinate mainly containing 1,3-dialkyl-2-imidazolidinone are separated.

1,3-dialkyl-2-imidazolidinone separated at the second extraction operation can be recycled as the first extracting solvent at the first extraction process again. On the other hand, the second extracting solvent, in which the aromatic halide compound is dissolved, is transferred to the distilling column 61, and is separated using the difference in boiling point between the two.

While the boiling point of PCB is in the range of 340to 648° C., the boiling point of 1,3-dialkyl-2-imidazolidinone is about 225° C., and the boiling point of hexane is 69° C. Therefore, in the case where hexane having low boiling point and PCB are separated by the distillation, the difference in boiling point between the two is large compared with the case in which PCB and 1,3-dialkyl-2-imidazolidinone are directly separated by distillation, as described in the first embodiment. Thus, the number of distillation stages required for The separation can be reduced. Therefore, distillation separation can be performed easily by using a small distilling column. Furthermore, distillation can be performed at a low temperature. The enriched aromatic halide compound obtained by the distillation operation is transferred to the aromatic halide compound enrichment tank 7. On the other hand, substances such as hexane and the like obtained by the distillation operation are returned to the second extracting solvent tank 9, and are recycled.

When the enriched aromatic halide compounds are, for example, harmful substances such as PCB and the like, the conventional decomposition processes such as a high temperature heat treatment and the alkaline reaction processing are employed for decomposition and detoxification.

Hereinafter, detailed conditions of the second extraction process and distillation process will be concretely described.

Note that the same condition as the condition employed in the first embodiment can be employed for the first extraction process.

<Second Extraction Process>

The second extraction process is a process to extract the aromatic halide compound in the extract obtained in the first extraction process, by using the second extracting solvents such as hexane and the like. For example, when hexane is used as the second extracting solvent, temperature of hexane in the extraction process is preferably adjusted to the range of 15 to 30° C. The mass ratio (SIF) of the mass (S) of the extract containing the aromatic halide compound to the mass (F) of hexane as the extracting solvent is not particularly limited, however, S/F is preferably in the range of 1 to 5 to operate the extraction.

The extraction operation method is not particularly limited, however a batch extraction method, a multiple extraction method, a continuous differential extraction method, a countercurrent multistage extraction method, a reflux extraction method, a fractional extraction method, a centrifugal extraction method and the like may be employed. When a stage number and an amount of an extracting solvent are the same, die countercurrent multistage extraction method is preferable as compared with the multiple extraction method which repeats a batch extraction operation more than once, from the viewpoint of high extraction rate and wide array of industrial utilization. The first extraction process and the second extraction process do not need to use the sane extraction method.

<Separation Process by Distillation>

The aromatic halide compound is enriched and removed from the second extracting solvent, in which the aromatic halide compound is dissolved, at the separation process by distillation.

For example, when hexane is used as the second extracting solvent, the distillation conditions preferably include ones having a distillation pressure in the range of 4 to 470 mmHg in a vacuum and a distillation temperature of 15 to 45° C. Note that the distillation pressure condition correlates with the temperature condition. When the pressure is set low, the temperature is preferably relatively low. By setting the above mentioned condition, it is possible to distill hexane. The distillation method is not specified, however a staged distilling column is preferably used.

In the removing method aromatic halide compound according to the third embodiment as well as the removing method according to the first embodiment, 1,3-dialkyl-2-imidazolidinone used as the first extracting solvent, has a low solidifying temperature, does not contain a sulfur component and is relatively harmless. Therefore, a safe separation process can be carried out. In addition, by adding the second extraction process (reversed extraction process), a load at the separation process by distillation is reduced, and the separation process by distillation can be carried out more easily.

In addition, oil can be recycled in the same manner as in the first embodiment. Therefore, a piping system to connect to the operating transformer directly may be prepared instead of the oil tank 1, and the insulation oil in the transformer is drained from one end and the recycled insulation oil after draining the aromatic halide compound may be returned to the transformers from the other end. Thus, the insulation oil and components inside the transformer can be processed while the transformer is being operated.

In addition, 1,3-dialkyl-2-imidazolidinone and the second extracting solvent can be recovered and recycled as well.

### Fourth Embodiment

A feature of a fourth embodiment is to add water to 1,3-dialkyl-2-imidazolidinone dissolving the aromatic halide compound, which is obtained at the first extraction process in the removing method in the third embodiment, and introduce the water added 1,3-dialkyl-2-imidazolidinone into the second extractor. By the addition of water, a recovery rate of the aromatic halide compound obtained after the second extraction process can be increased, the concentration of the aromatic halide compound in the recycled 1,3-dialkyl-2-imidazolidinone obtained after the second extraction process is further reduced, and the recycling of high purity 1,3-dialkyl-2-imidazolidinone can be achieved.

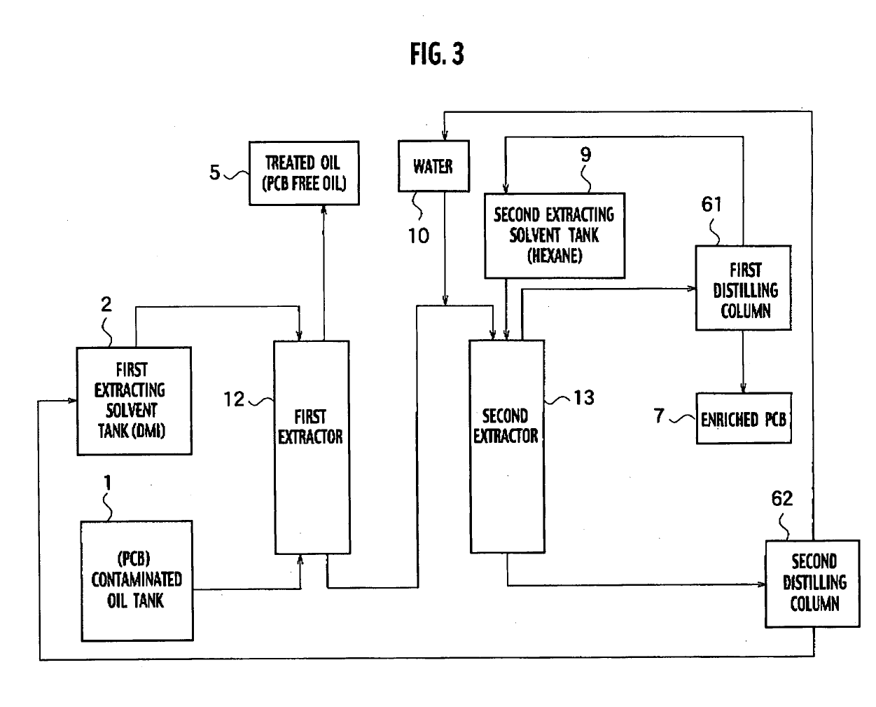

Hereinafter, the system and the method, which employs the system, of removing the aromatic halide compound in the fourth embodiment will be concretely described with reference to FIG. 3. Note that basic system is common to the system in the third embodiment. Therefore, the exemplification of duplicate part is omitted.

In addition, although pumps in each pipe arrangement are not given a graphic representation in FIG. 3 pumps may be accordingly arranged in places where needed. Furthermore, a continuous extracting apparatus, wherein extraction process and separation process are continuously carried out, is illustrated as an example, but a batch type extracting apparatus, which independently has an extraction tank and a phase separation tank, may also be employed.

In the system of the aromatic halide compound according to the fourth embodiment, water is added to an extract, in the process of transferring 1,3-dialkyl-2-imidazolidinone as the extract obtained in the first extractor 12, in which aromatic halide compound is dissolved, to the second extractor 13. For example, the water tank 10 is provided, and from the tank 10, the needed amount of water is added into 1,3-dialkyl-2-imidazolidinone in which the aromatic halide compound is dissolved. Thus, water-added extract, that is, 1,3-dialkyl-2-imidazolidinone aqueous solution in which the aromatic halide compound is dissolved, is transferred to the second extractor 13. Note that water concentration in 1,3-dialkyl-2-imidazolidinone aqueous solution is preferably in the range of 10% by weight or more.

As described in the second embodiment, as water concentration in 1,3-dialkyl-2-imidazolidinone aqueous solution increases, a solubility rate of the aromatic halide compound in 1,3-dialkyl-2-imidazolidinone aqueous solution tends to decrease. In the second extractor 13, the aromatic halide compound is extracted into the second extracting solvents such as hexane and the like, and solubility rate of the aromatic halide compound in 1,3-dialkyl-2-imidazolidinone aqueous solution which is raffinate decreases. Therefore, the recovery rate of the aromatic halide compound by the second extraction operation can be further increased.

For example, in the case where volume ratio (hexane/1,3-dialkyl-2-imidazolidinone) in the second extraction process is 1, when water concentration in 1,3-dialkyl-2-imidazolidinone aqueous solution is in the range of 10% by weight or more, a recovery rate of the aromatic halide compound increases as the water concentration increases. Furthermore, when the water concentration is 50% by weight or more, almost 100% by weight of the aromatic halide compound is recovered. Concentration of the aromatic halide compound in 1,3-dialkyl-2-imidazolidinone aqueous solution, which is the raffinate obtained at the second extraction process, can be set to be extremely low.

On the other hand, an increase in water concentration in 1,3-dialkyl-2-imidazolidinone aqueous solution results in a small difference in density of hexane and 1,3-dialkyl-2-imidazolidinone aqueous solution, and tends to make phase separation operation difficult. However water concentration in 1,3-dialkyl-2-imidazolidinone aqueous solution is 10% by weight, recovery rate of PCB is in the range of 70% by weight or more, in the case where volume ratio (hexane/1,3-dialkyl-2-imidazolidinone) in the second extraction process is in the range of 3 or more. Therefore, a high recovery rate of the aromatic halide compound can be obtained without difficulty of the phase separation operation by having volume ratio (hexane/1,3-dialkyl-2-imidazolidinone) in the range of 2 or more and preferably 3 to 4, and by having the water concentration in the range of 10% by weight or more but 50% by weight or less and preferably in the range of 10% by weight or more but 30% by weight or less.

The extract containing the second extracting solvent in which the aromatic halide compound is dissolved, is transferred to the first distilling column 61, wherein the second extracting solvents are substances such as hexane and the like. And the raffinate containing 1,3-dialkyl-2-imidazolidinone aqueous solution is transferred to the second distilling column 62, then distillation separation is carried out Hexane and the enriched aromatic halide compound are obtained from the first distilling column 61, and water and 1,3-dialkyl-2-imidazolidinone are obtained from the second distilling column 62. 1,3-dialkyl-2-imidazolidinone and water after the distillation are transferred to the extract tank 1 and water tank 10, respectively, and may be recycled.

According to the removing method in the fourth embodiment, in a similar fashion to the method of separation process in the third embodiment, 1,3-dialkyl-2-imidizolidinone used as the first extracting solvent does not contain a sulfur component and is relatively harmless, and therefore, the separation process can be carried our safely. Also, since the second extraction process (reversed extraction process) is added, a load at the separation process by distillation is reduced, and the separation process by distillation can be carried out more easily. Furthermore, by adding water to the extract obtained by using the first extracting solvent, a recovery rate of the aromatic halide compound is improved, and the concentration of the aromatic halide compound in the 1,3-dialkyl-2-imidazolidinone obtained at the second extraction process can be extremely decreased. Thus, the high quality first extracting solvent can be recycled.

Furthermore, oil can be recycled in the same manner as in the first embodiment. Insulation oil and components treatment in the transformer can be carried out while the transformer is being operated.

By employing the system according to the fourth embodiment, a distillation process can be carried out at low temperature in the range of 100° C. or below, and both an extracting solvent and water needed for extraction can be recycled. Therefore, an efficient closed system can be built.

Note that after the first extraction process in the fourth embodiment, water is added to its extract containing the first extracting solvent in which the aromatic halide compound is dissolved. However, water may be added to the first extracting solvent at the first extraction process in advance and further, water may be added to the extracted solution after the first extraction process. Furthermore, water may be directly added in the second extraction process. If water added 1,3-dialkyl-2-imidazolidinone aqueous solution is employed as the first extracting solvent at the first extraction process, it is not necessary to separate water from 1,3-dialkyl-2-imidazolidinone aqueous perfectly at the second distilling column 62.

### EXAMPLES

### Example 1

Using the method of removing according to the first embodiment of the invention, polychlorinated biphenyl (PCB) was removed and recovered from electric insulation oil containing a small amount of PCB with extraction process and separation process by distillation. 1,3-dimethyl-2-imidazolidinone (hereafter refer to as DMI) (specific gravity=1.06) was used as an extracting solvent of 1,3-dialkyl-2-imidazolidinone. Example 1 was carried out under the following condition. A sample was prepared as a sample to be treated, in which 0.1 g of PCB (KC500; distillation temperature range =365-390° C., at 760 mmHg) was added to 200 g of electric insulation oil (specific gravity=0.854). This corresponds to PCB concentration of 500 ppm. As for the specific extraction process, about 200 g of the electric insulation oil and 100 g of DMI as an extracting solvent were charged into a 500 ml separating funnel, then the funnel was shaken with an electric shaker for 30 min (250 SPM). After 1 hour of settling, each of the phase-separated raffinate phase (insulation oil phase) and extraction phase (extracting solvent (DMI) phase) were taken out and weighed respectively. PCB concentration in both phases was measured using an electron capture detector gas chromatography (ECD-GC). From these measurements, PCB distribution coefficient defined by the following equation (f1) in DMI as an extracting solvent was calculated.

PCB Distribution Coefficient [−]=(PCB concentration in extract [ppm])/(PCB concentration in raffinate [ppm]) (f1)

On the other hand, the mutual solubility between extracting solvent and insulation oil was evaluated using insulation oil loss, which was not recovered because of dissolution in extracting solvent. The ratio of insulation oil loss (% by weight) was the mass ratio, which is a mass of the insulation oil before separation to insulation oil loss.

### Comparative Example 1

In Comparative Example 1, Dimethyl sulfoxide (hereafter refer to as DMSO)(specific gravity=1.096) was used as an extracting solvent. Under the same conditions as Example 1 except for the extracting solvent, PCB was removed and recovered from an electric insulation oil sample containing 500 ppm of PCB using the procedure analogous to Example 1. PCB distribution coefficient in each extracting solvent and insulation oil loss were calculated.

### Comparative Example 2

In Comparative Example 2, Dimethylformamide (hereafter refer to as DMF)(specific gravity=0.94) was used as an extracting solvent. Under the same conditions as Example 1 except for the extracting solvent, PCB was removed and recovered from the electric insulation oil sample containing 500 ppm of PCB using the procedure analogous to Example 1. PCB distribution coefficient in each extracting solvent and insulation oil loss were calculated.

### Comparative Example 3

In Comparative Example 3, acetonitrile (specific gravity=0.782) was used as an extracting solvent. Under the same conditions as Example 1 except for the extracting solvent, PCB was removed and recovered from the electric insulation oil sample containing 500 ppm of PCB using the procedure analogous to Example 1. PCB distribution coefficient in each extracting solvent and the ratio of insulation oil loss were calculated.

### Comparative Example 4

In comparative Example 4, ethanol (specific gravity=0.81) was used as extracting solvent. Under the same conditions as Example 1 except for the extracting solvent, PCB was removed and recovered from the electric insulation oil sample containing 500 ppm of PCB using the procedure analogous to Example 1. PCB distribution coefficient in the extracting solvent and insulation oil loss were calculated.

(Results: Example 1 and Comparative Examples 1 to 4)

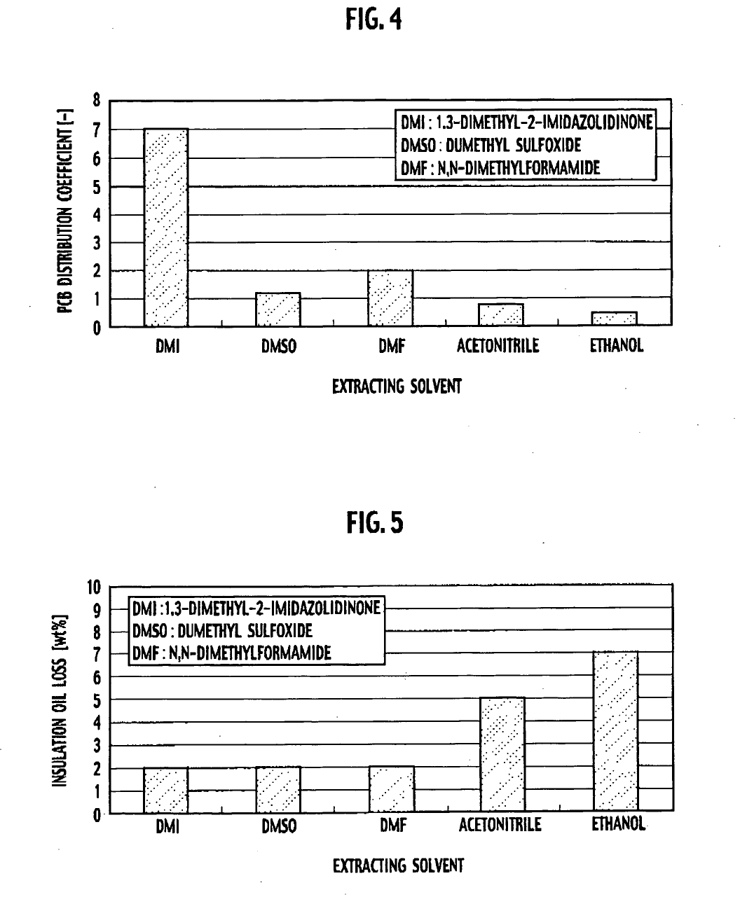

FIG. 4 shows PCB distribution coefficients for each extracting solvent of Example 1 and Comparative Examples 1 to 4. In addition, FIG. 5 shows the ratio of insulation oil loss (% by weight) for each extracting solvent of Example 1 and Comparative Example 1 to 4, which represents the mutual solubility between each extracting solvent and the insulation oil.

In FIG. 4, it is confirmed that PCB distribution coefficient for DMI used in Example 1, is extremely high compared to that of other extracting solvents. In FIG. 5, the loss ratio (DMI) used in Example 1 does not exceed The values for other extracting solvents used in Comparative Example 1 to 4. It is confirmed that the mutual solubility of DMI to insulation oil is low. It is concluded that the higher the distribution coefficient of PCB is and the lower the mutual solubility is, the higher the extraction capability of the extracting solvent. From these measurements, DMI used in Example 1 has an extremely high capability of extraction of PCB from insulation oil compared to other conventional extracting solvents.

### Example 2

In Example 2, aqueous solution of 1,3-dimethyl-2-imidazolidinone (DMI) used in Example 1 was used as an extracting solvent, in which water was added. The water concentration of the aqueous solution was 5% by weight. Under the same conditions as Example 1 except for the extracting solvent, PCB was removed and recovered from the insulation oil sample containing 500 ppm of PCB using the procedure analogous to Example 1. PCB distribution coefficient in the extracting solvent and the ratio of insulation oil loss were calculated.

### Example 3

In Example 3, aqueous solution of 1,3-dimethyl-2-imidasolisinon (DMI) used in Example 1 was used as an extracting solvent, in which water was added. The water concentration of the aqueous solution was 10% by weight Under the same conditions as Example 1 except for the extracting solvent, PCB was removed and recovered from the insulation oil sample containing 500 ppm of PCB using the procedure analogous to Example 1. PCB distribution coefficient in the extracting solvent and the ratio of insulation oil loss were calculated.

### Example 4

In Example 4, aqueous solution of 1,3-dimethyl-2-imidasolisinon (DMI) used in Example 1 was used as an extracting solvent, in which water was added. The water concentration of the aqueous solution is 30% by weight. Under the same conditions as Example 1 except for the extracting solvent, PCB was removed and recovered from the insulation oil sample containing 500 ppm of PCB using the procedure analogous to Example 1. PCB distribution coefficient in the extracting solvent and the ratio of insulation oil loss were calculated.

(Results: Examples 1 to 4)

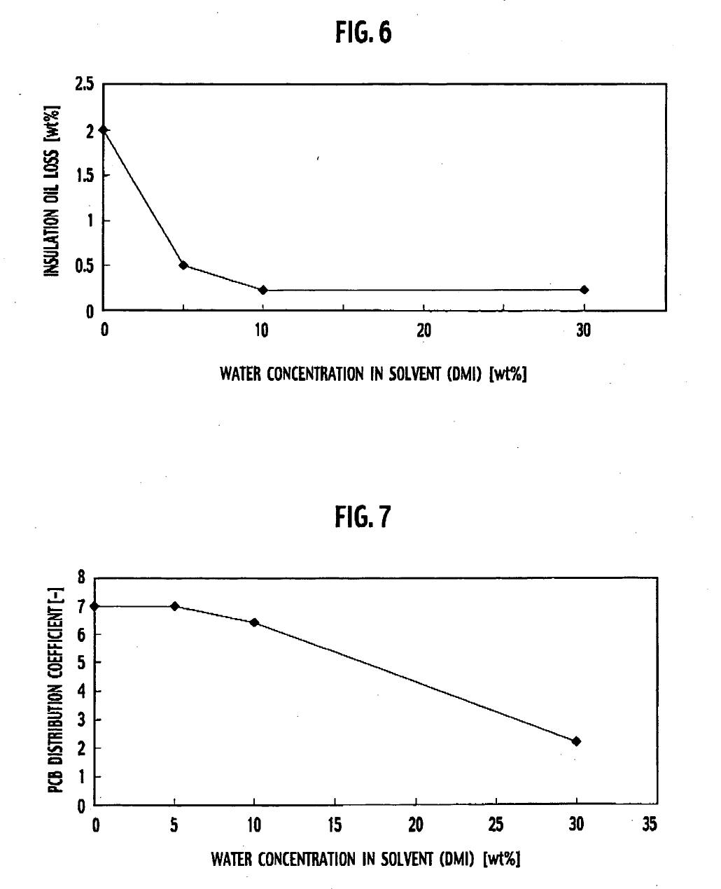

According to the measurements of the ratio of insulation oil loss and PCB distribution coefficient, FIG. 6 and FIG. 7 illustrate that the water concentration in solvent (DMI) has some effects on the mutual solubility of insulation oil and the distribution coefficient of PCB, respectively.

FIG. 6 shows that the solubility of insulation oil to an extracting solvent can be dramatically decreased when aqueous solution (DMI) is used in place of undiluted DMI solution. Particularly, the mutual solubility decreases quite a lot depending on the increase of water concentration in the range of 0 to 10% by weight, however, this tendency saturates over 10% by weight of water concentration.

While, FIG. 7 shows that when water concentration is not more than 10%, PCB distribution coefficient remains high, when water concentration is more than 10% by weight, the decrease of the distribution coefficient occurs according to the increase of the water concentration.

Consequently, it was confirmed that the use of aqueous solution of DMI as an extracting solvent, the water concentration ranging from 0.5 to 10% by weight, more preferably the water concentration ranging from 5 to 10% by weight, resulted in higher extraction efficiency compared to the use of undiluted DMI solution, because of lower mutual solubility of insulation oil and higher PCB distribution coefficient.

### Example 5

PCB was removed and recovered from the insulation oil sample containing 500 ppm of PCB using aqueous solution (DMI) of a 0.5% water concentration and the following procedures of extraction process and separation process by distillation.

As for the extraction operation, batch type multi extraction was carried out using a 500 ml separating funnel. Specifically, 200 g of the insulation oil sample containing 500 ppm of PCB described above and 100 g of aqueous solution (DMI) containing 0.5% by weight of water concentration as an extracting solvent were charged into a 500 ml separating funnel. The funnel was shaken for 30 min using an electric shaker (250 SPM). After one hour of settling, the content of the funnel was phase separated into the extract phase and raffinate phase. The extract phase was recovered and the raffinate phase was admixed with 200 g of a new extracting solvent. Then the above mentioned extraction operation was carried out repeatedly under the same condition. After five repetitions of a series of the extraction operation, PCB of more than 99.9999% was extracted into aqueous solution (DMI). The concentration of PCB in the extract (corresponding to 5 extraction repetitions) was around 200 ppm.

Next, DMI and water were separated from the extract by distillation. Two pieces of vacuum distillation apparatus in the laboratory (1000 ml) were applied for distillation operation. Firstly water having a boiling point 100° C. (at 1 arm), was separated using the first distillation apparatus. In the first distillation apparatus, distillation operation was carried out until the weight change of the still residue was not observed under the condition of 50 mmHg of distillation pressure and 60° C. of distillation temperature. Thus, a distillate not containing DMI and PCB, namely water, was separated and recovered. Next, DMI having a boiling point of 225° C., which was higher than that of water, was removed using the second distillation apparatus. Distillation operation was carried out until the still residue was reduced to about 2 g. Thus a distillate containing no impurity such as PCB, namely DMI was separated and recovered.

After recovering the still residue, PCB concentration in the still residue was 5% by weight upon measuring. As for the concentration ratio, PCB could be concentrated to about 100 Times higher than that of the starting material.

### Example 6

Using the method of separation according to the third embodiment of the invention, polychlorinated biphenyl (PCB) was removed and recovered from the electric insulation oil containing a small amount of PCB with the first extraction process, the second extraction process and separation process by distillation. 1,3-dimethyl-2-imidazolidinone (hereafter refer to as DMI)(specific gravity=1.06) was used as The first extracting solvent, and n-hexane was used as the second extracting solvent.

The first extraction process was carried out under the following condition. A sample was prepared by adding 100 g of PCB (KC300; distillation temperature range=365-390° C., at 760 mmHg) to 0.1 g of the electric insulation oil (specific gravity=0.854). This corresponds to PCE concentration of 1000 ppm. About 100 g of the above mentioned electric insulation oil sample and 100 g of DMI as an extracting solvent were charged into a 500 ml separating funnel under ambient temperature and atmospheric pressure. Then the funnel was shaken with an electric shaker for 30 min (250 SPM). After 1 hour of settling, each of the phase-separated raffinate phase (insulation oil phase) and extract phase (extracting solvent phase DMI) were taken out.

The second extraction process was carried out under the following condition. The same amounts of DMI obtained from the first extraction process as extract in which PCB is dissolved and n-hexane as the second extracting solvent were each charged into a 500 ml separating funnel so as to give a volume ratio (n-hexane/DMI aqueous solution) equal to 1. After shaking with an electric shaker for 30 min.(250 SPM), the funnel was settled for 1 hour. The phase-separated raffinate phase (DMI phase) and extract phase (hexane phase) were taken out and weighed respectively. Then PCB concentration was determined in both phases using an electron capture detector gas chromatography (ECD-GC). From these measurements, the recovery rate of PCB Rp was calculated using the following equation (f2).

Rp=(H*hp/Q*yn)*100 (f2)

Wherein, Rh: (PCB recovery rate)

Q: Extract mass

yn: mass fraction of PCB in extract

H: snipping solution mass

Hn: mass fraction of PCB in second extract solution (stripping solution)

### Example 7

In Example 7, polychlorinated biphenyl (PCB) was removed and recovered from the electric insulation oil containing a small amount of PCB using the first extraction, the second extraction and separation process by distillation. The first extraction process was carried out under conditions analogous to Example 6. Water was added to DMI in which PCB was dissolved to make aqueous solution (DMI) having water concentration of 10% by weight. The aqueous solution (DMI) in which PCB was dissolved was treated with the second extraction process. The phase-separated raffinate phase (DMI phase) and extract phase (hexane phase) were taken out and weighed respectively. Then PCB concentration was determined in both phases. From these measurements, PCB recovery rate was calculated. This example was carried out under the condition analogous to Example 6 except for the addition of water to DMI obtained in the first extraction.

### Example 8

In Example 8, polychlorinated biphenyl (PUB) was removed and recovered from the electric insulation oil containing a small amount of PCB using the first extraction process, the second extraction process and separation process by distillation. The first extraction process was carried out under conditions analogous to Example 6. Water was added to DMI in which PCB obtained was dissolved to make aqueous solution having the water concentration of 30% by weight The aqueous solution (DMI) in which PCB obtained was dissolved was treated with the second extraction process. The phase-separated raffinate phase (DMI phase) and extract phase (hexane phase) were taken out and weighed respectively. Then PCB concentration was determined in both phases. From these measurements, PCB recovery rate was calculated. This example was carried out under the condition analogous to Example 6 except for the addition of water to DMI obtained in the first extraction.

### Example 9

In Example 9, polychlorinated biphenyl (PCB) was removed and recovered from the electric insulation oil containing a small amount of PCB using the first extraction process, the second extraction process and separation process by distillation. The first extraction process was carried out under conditions analogous to Example 6. Water was added to DMI in which PCB obtained was dissolved to make aqueous solution having the water concentration of 50% by weight The aqueous solution of DMI in which PCB was dissolved was treated with the second extraction process. The phase-separated raffinate phase (DMI phase) and extract phase (hexane phase) were taken out and weighed respectively. Then PCB concentration was determined in both phases. From these measurements, PCB recovery rate was calculated. This example was carried out under the condition analogous to Example 6 except for the addition of water to DMI obtained in the first extraction

(Results: Examples 6 to 9)

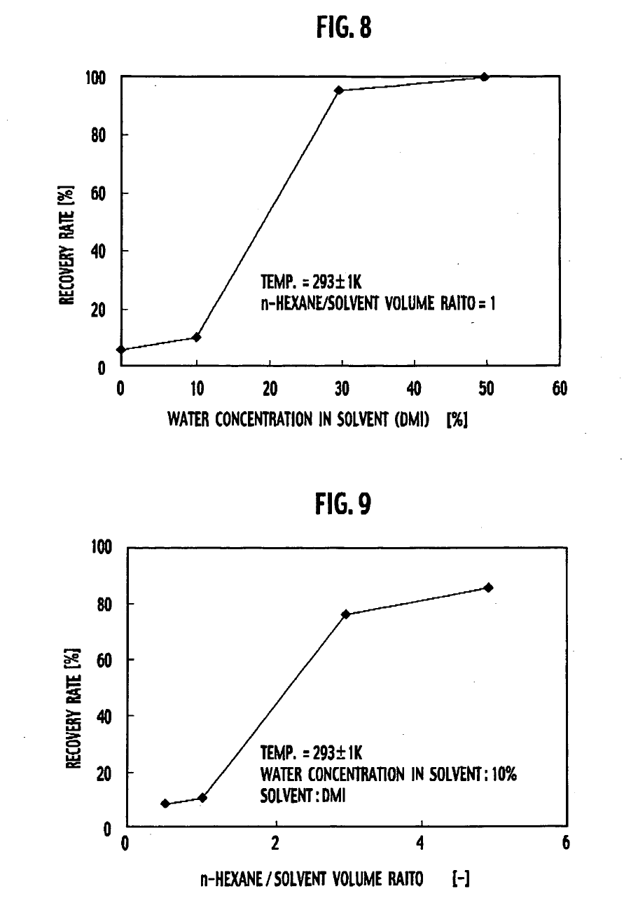

The relation between PCB recovery rate respectively measured in Examples 6 to 9 and the water concentration of the aqueous solutions is shown in FIG. 8. It is confirmed that when the water concentration exceeds 10% by weight, the recovery rate increases greatly. Thirty percent by weight of the water concentration gave about 90% by weight or more of PCB recovery rate and 50% by weight or more of the water concentration gave almost 100% by weight of PCB recovery rate.

### Example 10

In Example 10, polychlorinated biphenyl (PCB) was removed and recovered from the electric insulation oil containing a small amount of PCB using the first extraction process, the second extraction process and separation process by distillation The first extraction operation was carried out under conditions analogous to Example 6. Water was added to DMI in which PCB obtained was dissolved to make aqueous solution (DMI) having the water concentration of 10% by weight A predetermined amount of aqueous solution (DMI) in which PCB was dissolved and n-hexane as the second extracting solvent were charged into a 500 ml separating funnel so as to give a volume ratio (n-hexane/DMI aqueous solution) equal to 0.5. The second extraction operation was carried out under the condition analogous to Example 6. The phase-separated raffinate phase (DMI phase) and extract phase (hexane phase) were taken out and weighed respectively. Then PCB concentration was determined in both phases using an electron capture detector gas chromatography (ECD-GC). From these measurements, KCS recovery rate was calculated.

### Example 11

In Example 11, a predetermined amount of aqueous solution (DMI) having the water concentration of 10% by weight obtained by addition of water, in which PCB obtained from the first extraction process was dissolved and n-hexane as the second extracting solvent were charged into a 500 ml separating funnel so as to give a volume ratio (n-hexane/DMI aqueous solution) equal to 3. The second extraction operation was carried out under the same conditions as Example 6. The phase-separated raffinate phase (DMI phase) and extract phase (hexane phase) were taken out and weighed respectively. Then PCB concentration was determined in both phases using an electron capture detector gas chromatography (ECD-CC). From these measurements, PCB recovery rate was calculated. The conditions analogous to Example 10 were used except for the volume ratio.

### Example 12

In Example 11, a predetermined amount of aqueous solution (DMI) having the water concentration of 10% by weight obtained by addition of water, in which PCB obtained from the first extraction process was dissolved and n-hexane as the second extracting solvent were charged into a 500 ml separating funnel so as to give a volume ratio (n-hexane/DMI aqueous solution) equal to 5. The second extraction operation was earned out under the same condition of Example 6. The phase-separated raffinate phase (DMI phase) and extract phase (hexane phase) were taken out and weighed respectively. Then PCB concentration was determined in both phases using an electron capture detector gas chromatography (ECD-GC). From these measurements, PCB recovery rate was calculated. Conditions analogous to Example 10 were used except for the volume ratio.

(Results: Examples 7, and 10 to 12)

The relation between PCB recovery rate respectively measured in Example 7 and Example 10 to 12 and the volume ratio (n-hexane/DMI aqueous solution) is shown m FIG. 9. FIG. 9 shows that the increase of the volume ratio (n-hexane/DMI aqueous solution) improves the PCB recovery rate by a large amount. When the volume ratio (n-hexane/DMI aqueous solution) is 3, it gives PCB recovery rate of more than 70%. When the volume ratio (n-hexane/DMI aqueous solution) is 5, it gives relatively high PCB recovery rate of about 80%. Thus, it is confirmed that the adjustment of the volume ratio (n-hexane/DMI aqueous solution) results in high PCB recovery rate even when the water concentration of the aqueous solution (DMI) is about 10% by weight.

As described above, it is clear that the removing aromatic halide compound method of the present invention allows the aromatic halide compound to be effectively removed from contaminated oil with ease and safety compared to the conventional methods. Furthermore, the oil and extracting solvent after extracting the aromatic halide compound, can be recycled to save resources. Furthermore, a PCB contaminated transfer can be treated without taking a machine apart. Still furthermore, 1,3-dialkyl-2-imidazolidinone, which has a low solidifying point and does not contain sulfur, is employed, au an extracting solvent. Therefore, it is easy to handle it under normal temperature and can be applied to various kinds of conventional methods, when the aromatic halide compound is concentrated or concentrated aromatic halide compound is further applied to non-polluting treatment.

Having described the present invention according to the embodiments and examples, it is to be understood by those skilled in the art that the invention is not intended to be limited to any of these descriptions and that various kinds of modifications and improvement are included in the scope of the present invention.

What is claimed is:

1. A method of removing aromatic halide compound from oil containing the aromatic halide compound, comprising:
extracting the aromatic halide compound from the oil containing the aromatic halide compound by using a first extracting solvent containing 1,3-dialkyl-2-imidazolidinone, as a first extraction process.

2. The method according to claim 1, further comprising:
distilling the first extracting solvent dissolving the aromatic halide compound to separate the first extracting solvent from the aromatic halide compound, wherein the first extracting solvent dissolving the aromatic halide compound is obtained by the first extraction process.

3. The method according to claim 1, wherein the first extracting solvent is substantially a 1,3-diallyl-2-imidazolidinone aqueous solution.

4. The method according to claim 3, wherein water concentration in the first extracting solvent is in the range of 30% by weight or less.

5. The method according to claim 4, wherein water concentration in the first extracting solvent is in the range of 5% by weight or more, but 10% by weight or less.

6. The method according to claim 1, further comprising:
extracting the aromatic halide compound from the first extracting solvent dissolving the aromatic halide compound by using a second extracting solvent having a boiling point lower than a boiling point of the first extracting solvent, as a second extraction process, wherein the first extracting solvent dissolving the aromatic halide compound is obtained by the first extraction process.

7. The method according to claim 6, further comprising:
distilling the second extracting solvent dissolving the aromatic halide compound to separate the second extracting solvent from the aromatic halide compound, wherein the second extracting solvent dissolving the aromatic halide compound is obtained by the second extraction process.

8. The method according to claim 6, further comprising:
adding water to the first extracting solvent dissolving the aromatic halide compound, which is obtained by the first extraction process, before the second extraction process.

9. The method according to claim 8, wherein a water concentration in the first extracting solvent after adding the water is in the range of 10% by weight or more.

10. The method according to claim 8, wherein the second extracting solvent is substantially a paraffin hydrocarbon having a boiling point of 200° C. or less.

11. A system of removing aromatic halide compound from oil containing the aromatic halide compound, comprising:
a first supply source of a first extracting solvent containing 1,3-dialkyl-2-imidazolidinone;
a second supply source of the oil containing the aromatic halide compound; and
a first extractor which extracts the aromatic halide compound from the oil containing the aromatic halide compound supplied from the second supply source, by the first extracting solvent supplied from The first supply source.

12. The system according to claim 11, further comprising:
a first distilling column which distills the first extracting solvent dissolving the aromatic halide compound to separate a first extraction component from the aromatic halide compound, wherein the first extracting solvent dissolving the aromatic halide compound is obtained by the first extractor.

13. The system according to claim 11, wherein the second supply source is connected to an external device, and includes a piping system which supplies oil contained in the external device.

14. The system according to claim 11, further comprising:
a third supply source of a second extracting solvent having a boiling point lower than a boiling point of the first extracting solvent; and
a second extractor which extracts the aromatic halide compound from the first extracting solvent dissolving the aromatic halide compound by using the second extracting solvent, wherein the first extracting solvent dissolving the aromatic halide compound is obtained by the first extractor.

15. The system according to claim 14, further comprising:
a second distilling column which distills the second extracting solvent dissolving the aromatic halide compound to separate the second extracting solvent component and the aromatic halide compound.

16. The system according to claim 15, further comprising:
a water supply source which adds water to the first extracting solvent dissolving the aromatic halide compound, which is obtained by the first extractor.

17. The system according to claim 16, further comprising:
a third distilling column which distills the first extracting solvent added water to separate the water from the first extracting solvent, wherein the first extracting solvent added water is obtained by the second extractor.

18. The system according to claim 17, further comprising:
a first passage pipe which returns the second extracting solvent obtained from the second distilling column, to the second extracting solvent supply source;
a second passage pipe which returns the first extracting solvent obtained from the third distilling column, to the first extracting solvent supply source; and
a third passage pipe which returns water obtained from the third distilling column, to the water supply source
